(19) United States
(12) Patent Application Publication
(10) Pub. No.: US 2018/0153115 A1
(43) Pub. Date: Jun. 7, 2018

(54) Appratus for crop/plant/life-form cultivation

(71) Applicants: RAJESH EDKE, PUNE (IN); SWAROOP EDKE, PUNE (IN); SUPARNA EDKE, DOYLESTOWN, PA (US); SANIKA EDKE, PUNE (IN)

(72) Inventors: RAJESH EDKE, PUNE (IN); SWAROOP EDKE, PUNE (IN); SUPARNA EDKE, DOYLESTOWN, PA (US); SANIKA EDKE, PUNE (IN)

(21) Appl. No.: 15/732,621

(22) Filed: Dec. 6, 2017

Related U.S. Application Data
(63) Continuation of application No. 62/430,999, filed on Dec. 7, 2016.

(51) Int. Cl. A01G 31/06; A01G 27/00; A01G 9/24

(52) U.S. Cl. CPC A01G 31/06; A01G 9/246; A01G 27/003

(57) ABSTRACT

This invention relates to an apparatus for crop/plant/life-form cultivation that takes individual plant/life-form into consideration to cater to individual requirements of every plant/life-form by having automatic functions for scanning and offering nutrition/remedies with the help of sensors communicating wirelessly to controller, mobile phone and remote server.

The rotational/spiral/elliptical movement of the vertical grow station and the grow containers placed on it facilitates:
1. Easy access for harvesting individual plants.
2. lighting, heating and cooling needs of each individual plant/life-forms based on sensors
3. Circulation of air.
4. Pollination facilitation.
5. Water, fertigation, medication and nutrient dispensation to individual plant/life-form as per individual plant need.

The present invention attends to individual plant/life-form needs, reduces mortality, improving quality of the plant/life-form and enables picking up of ready to harvest plants via scanning plant data. This invention functions as an ‘All Care Unit’ for plants that is scalable and remotely operable.

### BACKGROUND OF THE INVENTION

### Limitations of the Prior Art

1. The prior art may be related specifically and limited to cultivation with vertical towers for growing crops or plants. The water/fluid based nutrients and the water/fluid circulation may be key to the growth of these plants.
2. The prior art may suffer in distribution of uniform light to each crop/plant/life-form. The prior art may be related to using PVC or Bamboo based vertical tower systems.
3. The prior art may use a vessel to store and pump to circulate water/fluid from below into the vertical towers or otherwise also connects the towers from above to circulate the water/fluid. The prior art allows the singular unidirectional rotation of the vertical towers. The prior art may be missing the aeration system because of lack of upward and downward movement in a spiral/elliptical/, circular, horizontal or elliptical fashion.
4. The prior art has fixed location for each grow-container along the vertical axis of the growing tower making it cumbersome to monitor and harvest. In prior art crop/plant/life-form size and crop/plant/life-form type are limited due to prior art design and limited space for root expansion.
5. In prior art, there may be limitation on the vertical height that can be achieved
6. In prior art, the harvesting may be done manually at intervals. In prior art, the artificial lighting is achieved generically: is same for all crop/plant/life-forms.
7. In prior art the air/fluid dispensing mechanism may not be present or if present it is achieved generically.

### BRIEF SUMMARY OF THE INVENTION

The present invention relates to an apparatus for crop/plant/life-form cultivation by protected or unprotected methods that reduces the physical area under cultivation with increased production due to the vertical space utilization and rotational spiral movement. Many functions related to the grow-containers like water, fluid or nutrient dispensing, air circulation and conditioning, medication dispensing and lighting system operations are controlled and monitored automatically for remote operation.

### BRIEF DESCRIPTION OF THE DRAWINGS

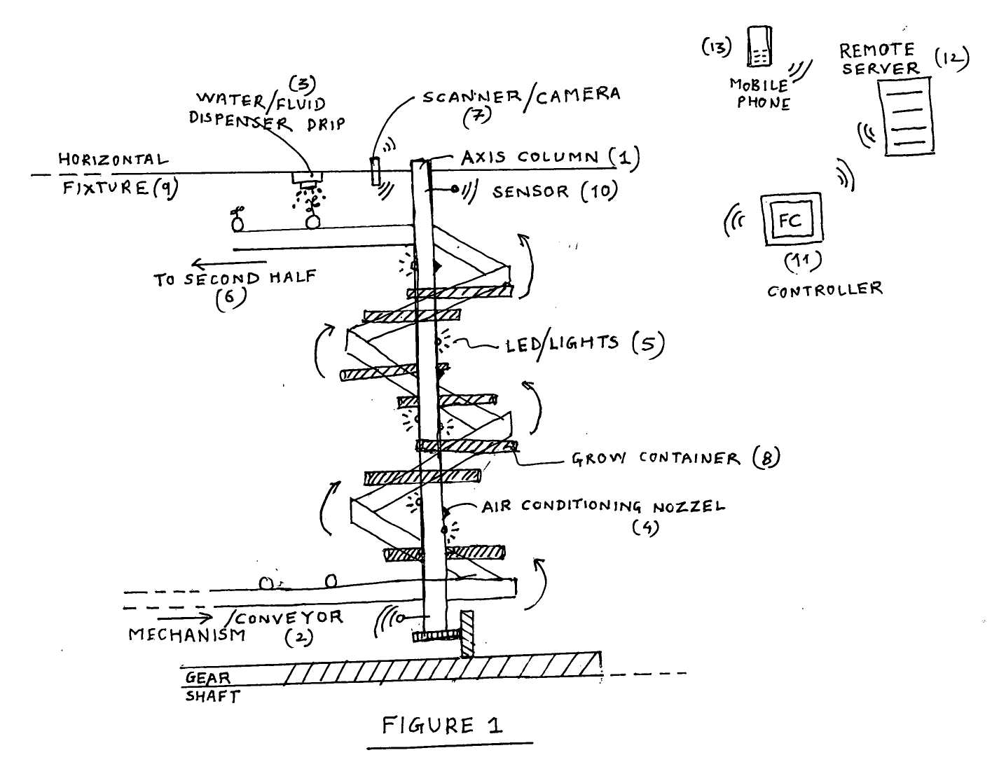

1. Referring to FIG. 1, a plant/life-form growing, sustaining and preservation station is shown. The apparatus shows a vertical middle column constructed and arranged with a hollow interior for creating an axis for the circumference—called Axis Column

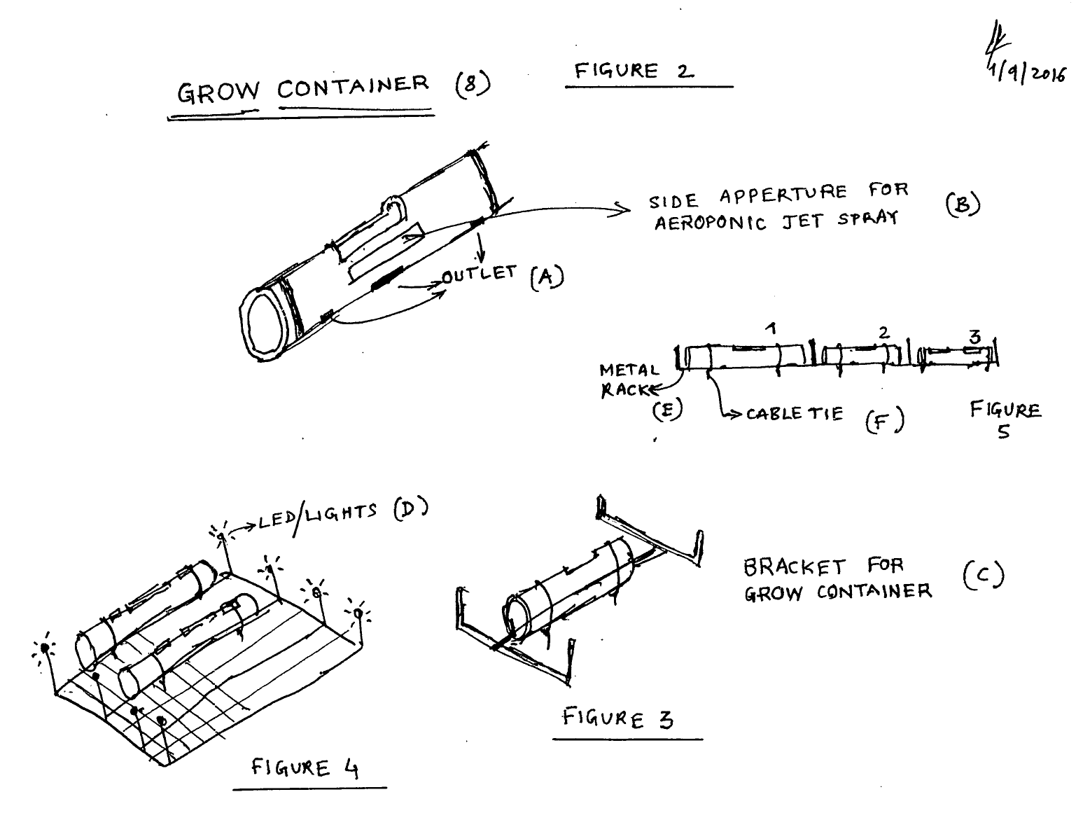

2. Referring to FIG. 2-FIG. 7, the drawings depict the shape, sizes and arrangement of singular and multiple grow-containers with extra attachments such as Outlet (A), Side Aperture for Aeroponic jet Spray (B), Bracket for Grow Container (C), Lights (D), Metal Rack (E), Cable Tie (F), Water Release Lever (G), Container Cap with Fluid Collection and Drain Plug (H) and Grommets with Vile to Drain Chamber (I).

### DETAILED DESCRIPTION OF THE INVENTION

A cultivation station, for purposes of this disclosure, is defined as a vertical spiral system having a plurality of grow-containers with water/fluid chambers and water/fluid circulation and fluid/nutrient distribution system. This grow station is built around vertical axis with a rotation capacity and movable mechanisms that move up and down in spiral/elliptical/motion carrying the grow containers. These stations can be stand alone (FIG. 1) or be interconnected along with a grow container, and/or water/fluid circulation system, and/or air conditioning/gas distribution/medication dispensing system, and/or lighting system. These systems can be controlled based on the input of sensors which communicate to controller, mobile phone and in turn to remote server.

The station axis with modules having a hollow interior and water/fluid dispensing system at the top-end, air conditioning/gas distribution/medication dispensing system at the bottom-end and lighting system along the grow containers which can be separated from the station axis and is replaceable with other grow-containers. The station axis surrounded throughout its circumference with spiral/elliptical/mechanism system that moves along its axis in upward and downward motions in order to make movement of the grow-containers. The grow-containers are placed—on the mechanism along its spiral/elliptical/vertical axis from bottom of the grow station until the top of the grow station. This movement is meant to facilitate the air conditioning/gas distribution/medication dispensing for the crop/plant/life-forms along with uniform lighting to every crop/plant/life-form, fertigation to each grow container and additionally providing access to each crop/plant/life-form for monitoring and harvesting.

In this embodiment the apparatus includes a crop/plant/life-forming column which is the axis of the aforementioned growing station which has multiple growing containers—placed on a moving mechanism whose movement is spiral/elliptical/upward and downward along the vertical axis.

In this embodiment, other ancillary systems vital to the function of this growing station include water/fluid, nutrient circulatory apparatus, gas distribution apparatus/lighting apparatus as well as air purification and fogger apparatus to enhance crop/plant/life-form growth. The movement on the spiral/elliptical/axis enhances the chances of pollination, air conditioning/gas distribution/medication dispensing, aeration, pesticide spraying, heating and cooling and even light distribution to each crop/plant/life-form. The water/fluid, nutrient and specific gas and medication/gas (CO2 etc.) spraying/distribution is given individually to each grow-container.

In this embodiment, the separate grow-containers can be removed from the main vertical axis for further monitoring, improving and harvesting and can be fixed again to the main axis with a new life-form for next harvesting cycle. Therefore harvesting of produce may not be limited to manual harvesting.

In this embodiment, each vertical grow station stands sufficient on its own as well as can be connected with other growing stations.

In this embodiment there is no restriction on use of material. In this embodiment, this system need not have any vertical limitation of height. In this system height of the grow station and subsequently the number of crop/plant/life-forms can be increased or decreased as per need. In this embodiment the cultivation can be done in open fields as well as under protected greenhouses and also within the confinement of urban dwellings. In this embodiment the type of cultivation need not limit itself to soil based or water nutrients substrates alone. It can accommodate regular soil cultivation as well as other new substrate systems already available. In this embodiment the roots expansion can happen freely.

This embodiment can also be used for cultivating insects, bacteria, cells, and any other life form which could be useful for consumption.

In this embodiment the mechanism/conveyor system of the single or twin Towers which move the grow stations or pods can be connected to mechanically driven shaft and gear system. In the rural area even cattle moving in circle can move gear which will be connected to all the power system this way even if there is no electricity or generator backup power you can use the cattle for this modern age farming purpose.

### DETAILED DESCRIPTION OF DRAWINGS

With reference to the drawings the invention will now be described in more detail. Referring to FIG. 1, a plant/life-form growing, sustaining and preservation station is shown. The apparatus shows a vertical middle column constructed and arranged with a hollow interior for creating an axis for the circumference—called Axis Column (1). Planting ports/Grow Containers (8) are located on the circumference along the axis in a spiral/elliptical fashion on the mechanism/conveyor (2) that moves upward and downward. These planting ports hold grow-containers (8). A water/fluid drip (3) is installed on the horizontal fixture on the top (9) that is used for dispensing water/nutrients or any other required liquid to the grow container (8). As soon as a grow container (8) reaches the top of the axis column (1), the water/fluid drip (3) is able to release the required quantity of water/nutrients/liquid to the grow container (8). As shown in FIG. 1, Air Conditioning Nozzle (4) is given as an aperture on the Axis Column (1). This enables cool or warm air to be circulated along the grow containers (8). Temperature control for different life-forms can be monitored for individual grow containers (8) with the help of this nozzle (4). Lights (5) are placed on the main Axis Column (1) in order to provide additional light as per spectrum requirements of plant/life-form on every level of grow-container (8). The main Axis Column (1) helps for upward movement and a similar axis Column (1) would be established for downward movement as shown in FIG. 1 and called as ‘To Second Half’ (6). Scanner (7) is provided at the top of the axis Column (1) on the horizontal fixture (9) in order to scan and keep track of the Grow Container (8). It also serves the purpose of identifying the plant/life-form that has been planted in that particular grow container (8). This scanning system is connected to the water drip (3) to regulate the nutrients as per the code scanned. The scanned code will also be integrated with the price of the plant/life-form at time of selling. The actions of fluid drip (3), lights (5), Air conditioning nozzle (4), scanner (7) are activated by sensors (10) and managed via communication with controller (11), handheld devices like mobile phone (13) and remote server (12). Communication is achieved via various wireless protocols.

Grow Containers (8): FIG. 2-FIG. 7:

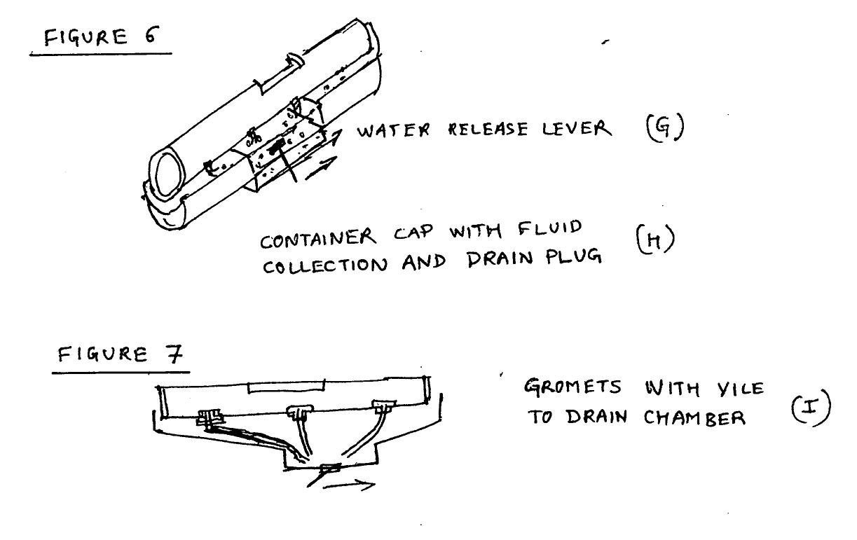

Grow Containers (8) are essentially plant/life-form holders which can be of many types and can be made up of any materials. FIG. 2 Grow-Container (8) is typically horizontal with side panels with outlets (A) on the bottom and side apertures for aeroponic jet spray (B). FIG. 3 Grow Container (8), is showing a way of holding the grow-container (8) by placing a bracket (C) for the grow-container (8). FIG. 4 Grow Container (8) shows multiple grow-containers placed on one plane with a larger bracket and placement of Lights (D) for illumination and photo-synthesis. FIG. 5 Grow Container (8) shows a linear placement of grow containers (8) with a metal rack (F) below and the method of holding the grow-containers (8) in one place by using a cable tie (F). FIG. 6 Grow Container (8) shows the way in which water/waste and excess fluid/liquid can be released with the help of water release lever (G). Embedded in FIG. 6 grow-Container (8) is a container cap with fluid collection and Drain plug (H). FIG. 7 grow-Container (8) shows the placement of grommets with vile to drain chamber (I).

While the preferred embodiment of the invention has been described using specific terms, such description is for illustrative purposes only and it is to be understood that changes and variations may be made without departing from the spirit or scope of the mentioned claims.

1. A cultivation or grow station which has an axis that is essentially vertical having plurality of grow-containers with fluid/nutrient distribution system and which moves in a spiral/elliptical/vertical axis and this movement is meant to facilitate the air conditioning/gas distribution/medication dispensing for the crop/plant/life-forms along with uniform lighting to every crop/plant/life-form and additionally providing access to each crop/plant/life-form for monitoring, controlling and harvesting via wireless communication between sensors, controller, mobile phone and remote server.

2. And, single or multiple grow-containers are placed on the grow station mechanism along its spiral/elliptical/vertical axis from bottom of the grow station until the top of the grow station.

3. And, the grow stations can be connected to mechanically driven shaft and gear system whereas electricity is not a requirement and in the rural areas even cattle moving in circle can move the gear connected to the embodiment.

4. This grow station, according to claim 1, will be built along a vertical axis with a rotation capacity and movable mechanisms that move up and down in spiral/elliptical/motion carrying the grow containers along with its movement.

5. The cultivation station axis, according to claim 1, has modules having a hollow interior and water/fluid dispensing system at the top-end, air conditioning/gas distribution/medication dispensing system at the bottom-end or along the axis and lighting system along the grow containers, according to claim 2, which can be separated from the station axis and is replaceable with other grow stations.

6. In this embodiment, according to claim 1, other ancillary systems vital to the function of this growing station include water/fluid, nutrient circulatory apparatus, gas distribution apparatus/lighting apparatus as well as air purification and fogger apparatus to enhance crop/plant/life-form growth and the movement on the spiral/elliptical/axis enhances the chances of pollination, air conditioning/gas distribution/medication dispensing, aeration, pesticide spraying, heating and cooling and even light distribution to each crop/plant/life-form and the water/fluid, nutrient and specific gas and medication/gas (CO2 etc.) spraying/distribution can be given individually to each grow-container.

7. These grow stations according to claim 1, can be stand alone or interconnected along with Grow-Container, water/fluid circulation system, air conditioning/gas distribution/medication dispensing system, lighting system.

8. The cultivation station axis according to claim 1, surrounded throughout its circumference with spiral/elliptical/mechanism system that moves along its axis in upward and downward motions in order to make movement of the grow-containers along the axis.

9. In this embodiment according to claim 1, each vertical grow station stands sufficient on its own as well as can be connected with other growing stations.

10. In this embodiment according to claim 1, this system need not have any vertical limitation of height and height of the grow station and subsequently the number of crop/plant/life-forms can be increased or decreased as per need.

11. In this embodiment according to claim 2, the separate grow-containers can be removed from the main vertical axis for further monitoring, improving and harvesting and can be fixed again to the main axis with a new life-form for next harvesting cycle.

12. In this embodiment, according to claim 1, there is no restriction on use of material.

13. In this embodiment, according to claim 2, there is no restriction on use of material.

14. This embodiment, according to claim 1, can also be used for growing insects, bacteria, cells, and any other life form which could be useful for consumption.

15. This embodiment, according to claim 2, can also be used for growing insects, bacteria, cells, and any other life form which could be useful for consumption.

16. In this embodiment, according to claim 3, the farming can be done in open fields as well as under protected greenhouses and also within the confinement of urban dwellings.

17. In this embodiment, according to claim 3, the type of cultivation need not limit itself to hydroponics as it can accommodate regular soil cultivation as well as other new systems such as aquaponics, aeroponics etc.
